(19) United States
(12) Patent Application Publication
(10) Pub. No.: US 2014/0259019 A1
(43) Pub. Date: Sep. 11, 2014

(54) TEN LEVEL ENTERPRISE ARCHITECTURE HIERARCHICAL EXTENSIONS

(71) Applicant: Kerry John Enright, Mira Loma, CA (US)

(72) Inventor: Kerry John Enright, Mira Loma, CA (US)

(21) Appl. No.: 13/793,361

(22) Filed: Mar. 11, 2013

(51) Int. Cl. G06F 9/46

(52) U.S. Cl. CPC G06F 9/46
USPC 718/102

(57) ABSTRACT

The HIERARCHICAL EXTENSIONS enhances the TEN-LEVEL ENTERPRISE ARCHITECTURE SYSTEMS AND TOOLS by empowering enterprises to construct, standardize, execute, measure and improve execution across any level of enterprise activity. This continuation in process includes:
1. Additional structure for execution precision
2. Tightly integrated control of subordinate processes
3. Templates to standardize execution models
4. Jobs to execute templates
5. Cell coding to provide element control
6. Universal identification of any model element, transaction or job
7. Embedded monitor, evaluate and control capability
8. Overlay analysis method for any activity or element of the enterprise
9. Enterprise fabric management for rules, information, data and specifications
10. Trigger creation method and tools

### CROSS-REFERENCE TO RELATED APPLICATIONS

This application is a continuation in process of U.S. application Ser. No. 13/541,556 titled “TEN-LEVEL ENTERPRISE ARCHITECTURE SYSTEM AND TOOLS” filed Jul. 3, 2012.

### BACKGROUND OF THE INVENTION

1. Field of the Invention

The disclosed technology relates to a method of extending and applying the TEN-LEVEL ENTERPRISE ARCHITECTURE SYSTEMS AND TOOLS to perform enterprise-wide execution control in a highly integrated structure.

2. Description of the Related Technology

Complex enterprises manage processes across multiple dimensions including end to end, and top to bottom to top in order to meet the demands of the marketplace. Unfortunately, such enterprises are constrained in their ability to execute across multiple dimensions because of the lack of methods and systems that empower such execution. While many enterprise claim that they drive processes end to end, true end to end process control requires extensive hierarchical process management. The reason for this is that any end to end process lies on top of a large hierarchy of subordinate processes distributed across multiple sites.

A number of process management techniques purport to provide end to end process control, but in reality fail to do so. For example, value stream mapping methods claim to provide end to end process definition and control points and yet its very structure is based on a single dimensional structure—a straight line. Similarly, swim lane methods appear to provide more than one dimension because they provide multiple lanes for a process. Unfortunately, these swim lane methods are really 1+ dimensional process methods since the different lanes are effectively elements supporting a single dimension. When and if they traverse more than one dimension of control, the lines of hierarchical hand off are ambiguous at best.

Execution monitoring and control however becomes more complicated for enterprises than even dimensional management. Multiple execution issues arise such as how do enterprises manage linkages between processes completely and correctly, how do enterprises identify and assess the elements of execution within its domain, how do enterprises monitor and control execution throughout the enterprise or how do enterprises capture, disseminate and execute best practices throughout its domain? These are issues that current state of the art fails to adequately address in a common, predictable, complete and correct fashion.

### SUMMARY OF CERTAIN INVENTIVE ASPECTS

The Ten-Level Enterprise Architecture execution extensions and applications described in this disclosure enhance the Architecture's unique process control allowing enterprises to articulate and control execution across any level of process hierarchy and as a result manage true end to end processes as well. The innovative elements to enable advanced enterprise execution logic control include the following.

1. A method of managing four process elements within the Ten-Level Enterprise Architecture Initiate, Execute and Complete methods and systems which are material, implement, resource and tool
2. A method of inserting Start and End delimiters for the Execute Process and Execute Measure functions to enable precise process condition identification and control of supervisory and subordinate processes
3. A method to enable precise executional order of processes and accommodate exception conditions
4. A method of triggering and controlling the order of subordinate processes from supervisory processes
5. A method of triggering and controlling subordinate process in conditions of parallel execution
6. A method of creating common templates for categories of processes
7. A method for creating jobs to provides specific execution of work based on a template
8. A method for providing functional attributes to specific cells or groups of cells within a process
9. A method of precisely identifying every process element or collection of elements anywhere in the enterprise
10. A method of naming and defining the contents of levels of process hierarchy in an enterprise
11. A method for identifying specific transactions between levels of process hierarchy
12. A method of specifically identifying jobs within an enterprise
13. A method to monitor, evaluate and control any process at any level of the enterprise
14. A method to conduct an overlay analysis of any element or collection of elements in the enterprise to assess their performance
17. A method to manage rules, information, data and specifications as an enterprise fabric
18. A method to trigger processes from stimuli, messages, requirements and autonomous triggers.

These methods provide a level of enterprise process clarity and control across multiple dimensions that are unprecedented and deliver significant execution control heretofore unavailable.

### BRIEF DESCRIPTION OF THE DRAWINGS

FIG. 1 Image of the four execution elements in the initiate phase

FIG. 2 Image of the four execution elements in the complete phase

FIG. 3 Image of the start/transform/end and start/measure/end structure

FIG. 4 Image of the function/order for cardinality and exception logic

FIG. 5 Image of the triggering and response of a subordinate process

FIG. 6 Image of the triggering and response of multiple subordinate processes

FIG. 7 Image of subordinate process order control

FIG. 8 Image of the management of parallel process interoperability

FIG. 9 Image of a template contents

FIG. 10 Image of initiating a job from a template

FIG. 11 Image of cell instructions and coding methodology

FIG. 12 Image of step identification in the initiate sub-process

FIG. 13 Image of step identification in the execute sub-process

FIG. 14 Image of step identification in the complete sub-process

FIG. 15 Image of column and cell identification method

FIG. 16 Image of process identification across levels of hierarchy

FIG. 17 Image of names and functions of process hierarchy

FIG. 18 Image of identification method of supervisory-subordinate transactions

FIG. 19 Image of template to job content conversion and identification change

FIG. 20 Image of monitor, evaluate and control process template

FIG. 21 Image of control signal to aberration process response

FIG. 22 Image of the summation of performance metrics across hierarchies

FIG. 23 Image of overlaying template RIDS to performance

FIG. 24 Image of overlaying template steps to performance

FIG. 25 Image of overlaying template enablers to performance

FIG. 26 Image of overlaying job RIDS to performance

FIG. 27 Image of overlaying job elements to performance

FIG. 28 Image of overlaying common elements against RIDS performance

FIG. 29 Image of overlaying common templates against time performance

FIG. 30 Image of overlaying common templates against location performance

FIG. 31 Image of overlaying steps against performance

FIG. 32 Image of overlaying rules against performance

FIG. 33 Image of next job transfer of RIDS enterprise fabric

FIG. 34 Image of subordinate job transfer of RIDS enterprise fabric

FIG. 35 Image of same job transfer of RIDS enterprise fabric

FIG. 36 Image of separate job transfer of RIDS enterprise fabric

FIG. 36 Image of ad hoc transfer of RIDS enterprise fabric

FIG. 38 Image of RIDS enterprise fabric dispatch control elements

FIG. 39 Image of stimulus processing in trigger creation engine

FIG. 40 Image of message processing in trigger creation engine

FIG. 41 Image of requirements processing in trigger creation engine

FIG. 42 Image of trigger processing in trigger creation engine

### DETAILED DESCRIPTION OF CERTAIN INVENTIVE EMBODIMENTS

The extensions to the Ten-Level Enterprise Architecture provide methods and systems allowing enterprises unprecedented precise of control over hierarchical and end to end processes. The explanation below describes how these extensions resolve the limitations of prior art.

### 1. Management of Four Process Elements

### Current Constraint

Current state of the art process controls fail to explicitly account for the four basic elements that require management needed for complete process execution—implement, material, resource and tools. Implement represents the physical and logical fixtures that enable the execution of the process step. Material is the actual entity subject to transformation or measurement. Resource represents the agent that provides the intelligence and trigger required to execute the step. Tools are the technologies that enable the execution.

### The Innovation

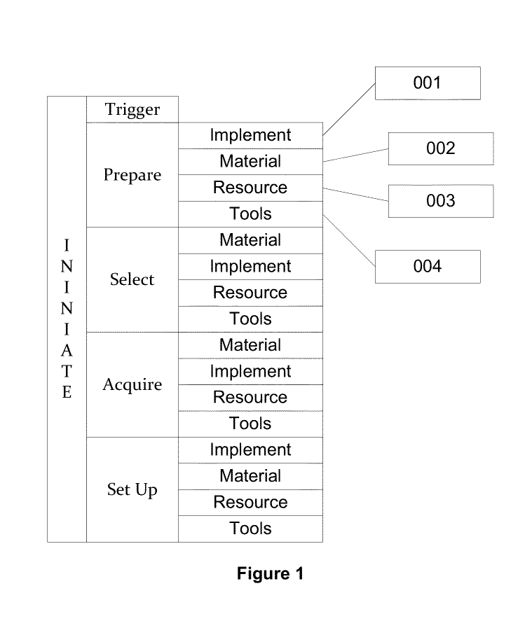

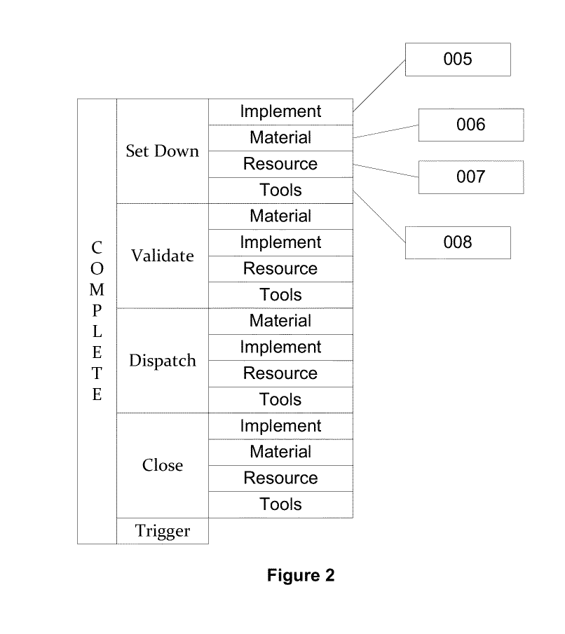

As shown in FIG. 1, the method provides for explicit management of the implement, 001, material, 002, resource, 003, and tools, 004 for each section of the initiate sub-process operations including prepare, select, acquire and set up. FIG. 2 shows that the same structure exists for the complete sub-process—items 005 through 008—which are repeated for set down, validate, dispatch and close operations. For example, the set down/implement operation may specifically address activities such as removing a fixture from a process tool while the set down material operation may address the removal of the material from the process equipment. This method ensures that each operation will perform work explicitly on each of the four elements to insure their correct execution.

### The Meaning

This method provides complete recognition and control of these four essential elements at every stage of execution to ensure process completeness. One of the leading causes of misprocessing is incompleteness and the method of explicitly enforcing the management of these elements enables process completeness.

### 2. Execute Structure

### Current Constraint

Current state of the art process controls lack explicit structure around the execution of every transformation or measurement. This lack of structure limits the ability of enterprises to associate transformations or measurements precisely in space and time and to associate the four process elements—material, implement, resource and tool—to a process step.

### The Innovation

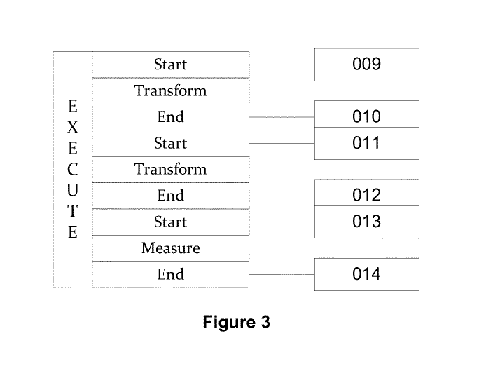

As shown in FIG. 3, every material transformation is enclosed by a start and an end step, 009-010 and 011-012, or material measurement, 013-014. The start step triggers the transformation or measurement and logs the implement, material, resource, tool, date, time and location of the transformation or measurement. The end step terminates the transformation or measurement and logs its implement, material, resource, tool, date, time and location.

### The Meaning

Enterprises gain precise control and recording of the exact composition and boundaries of any transformation or measurement and provide an opening for hierarchical process control described below. The enforcement of transformation boundaries and the recording of the execution contents play a major role in process traceability, improvement and the control of finite resources. The role of execute structure in hierarchical control will be explained in section the Subordinate Process Control below.

### 3. Order Management

### Current Constraint

Current enterprise state of the art tools lack a formal structure for embedding execution order and the formal structure to execute exception processing at any process step. As a result, process order and exception control can only be provided on an ad hoc basis.

### The Innovation

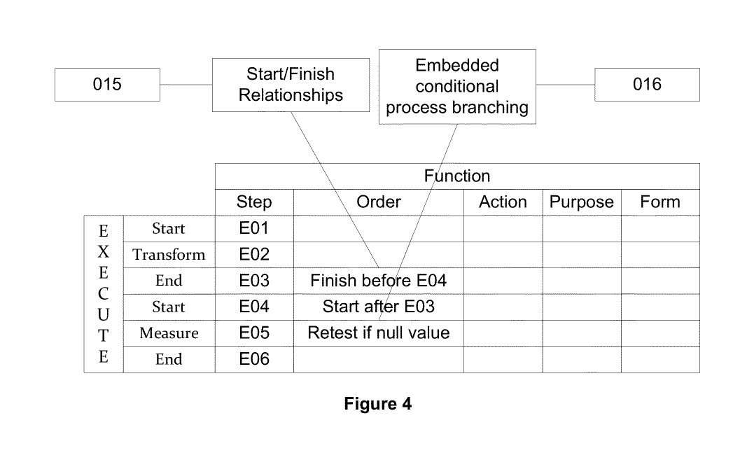

The function order method, FIG. 4, provides multiple capabilities for managing process order. First, the function order provides space to define process step order such as start before or finish after named steps, 015, within each sub-process—initiate, execute and complete. This determines the degree of execution freedom and cardinality within the sub-process and the instructions can be defined in both text and system level code, the latter in brackets. The function order method confines itself to the boundaries of the specific sub-process—initiate, execute or complete—to avoid process errors. Additionally, the function order method can contain pre-defined pointers to trigger alternative processes in cases of process step aberrations or exception conditions, 016. If the process step experiences defined conditions, it triggers the conditional process.

### The Meaning

This method of managing process order allows every step of the enterprise to have its execution order defined within logical boundaries of complete execution. This allows flexibility and control. It also embeds predetermined conditional branching so that exceptions and aberrations can be handled in a predetermined and controlled fashion.

### 4. Subordinate Process Control

### Current Constraint

Enterprises of any complexity need to manage execution over set of processes executed in hierarchical order as well as linear order. State of the art tools however are designed for linear order and neglect or overlook the natural hierarchical nature of processes and their interlocking structure. This oversight places a strain on enterprises that need a common and predictable framework for executing multiple levels of process control.

### The Innovation

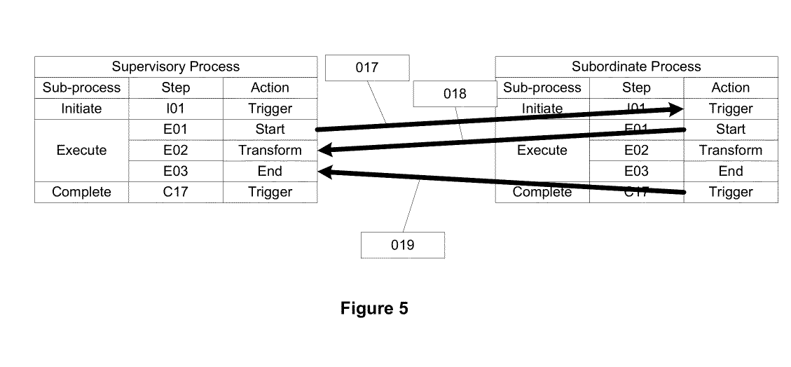

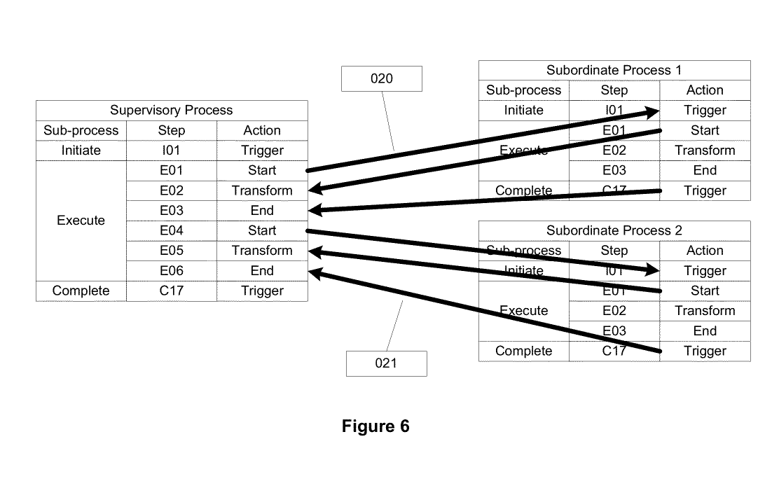

The execute structure as shown in FIG. 3 can be applied to a method of managing subordinate process control as shown in FIG. 5. The execute start, execute transform/measure and execute end structure allows for precise triggering and integration between supervisory and subordinate processes. The 017 execute start operation of the supervisory process sends a start trigger to the subordinate process. When the subordinate process reaches its own execute start operation, it sends an update to the supervisory process execute transform or execute measure operation, 018. Upon reaching the complete trigger operation, the subordinate process sends a trigger, 019, to the supervisory process execute end operation to close out the work. The supervisory process can trigger and execute multiple subordinate processes as shown in FIG. 6 and can control them by separate transformation or measurement processes, 020 and 021.

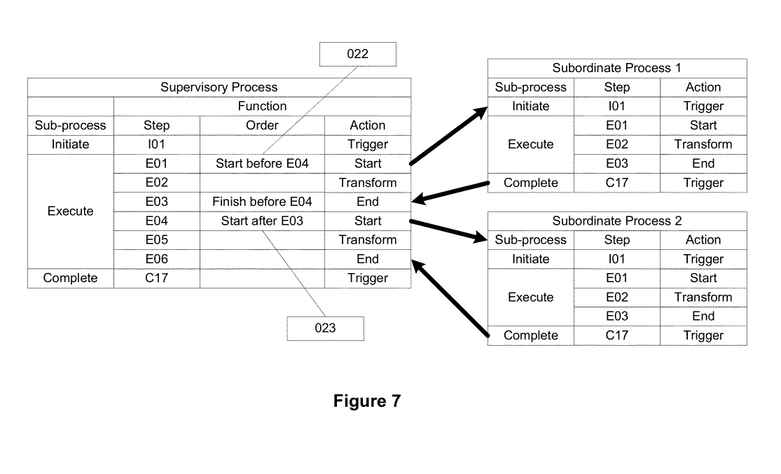

The supervisory process can control the order in which these processes are executed by using the function order method. In FIG. 7, the sequential order of subordinate process 1 and subordinate process 2 is tightly controlled by the function order method of the supervisory process, 022 and 023. These linkages between supervisory processes and subordinate processes have no hierarchical limits since a subordinate process in turn can become a supervisory process by triggering its own subordinate process.

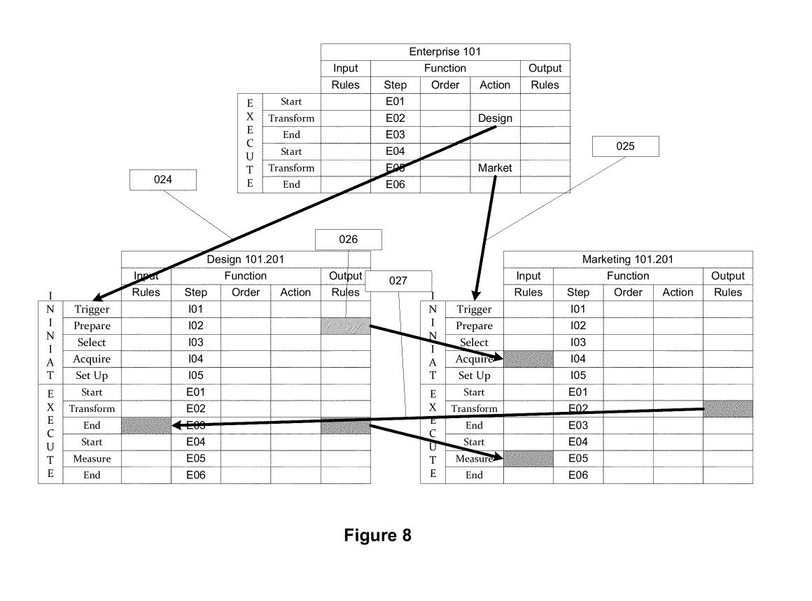

Enterprises often find themselves in situations where different functional areas need to work in concert on related programs that require massively parallel execution over time. In such cases, these distinct and separate functional areas face mutual dependencies where they require interlocking exchanges of rules, data, information and specifications. FIG. 8 provides the method in which these difficult exchanges can employ intimate process linkages. The supervisory process can trigger the work of separate functional areas to commence, 024 and 025, but once the work has started, the execution linkages are not hierarchical but massively parallel. The Marketing function may be dependent on rules, information, data or specifications from the Design function and therefore the completion of action, 026, in the Design function provides an input for the Marketing activities. Conversely, the Marketing function, 027, can produce rules that are essential to the work of the Design group. This form of massive parallelism allows the clear and correct injection of rules, information, data and specifications into cooperative processes.

### The Meaning

The subordinate process control method offers a level of hierarchical process control that enables enterprises to overcome the limitations of current state of the art and provide them with precise control over any number of layers of process control.

### 5. Template Creation

### Current Constraint

Enterprises need to drive continuous change not only to adapt to an evolving environment, but also to gain strategic advantage. The current state of the art however impedes the speed, cost and quality at which enterprises are able to transform. Typical transformation programs require multiple levels of translation from the strategic vision to models of the desired process to the development of specific application code. Enterprises find their ability to transform themselves is severely limited by the need to endure such layers of translation, to define effective execution models and accept the bottlenecks associated with software development. They spent an unnecessary amount of time on how to execute as opposed to what to execute.

### The Innovation

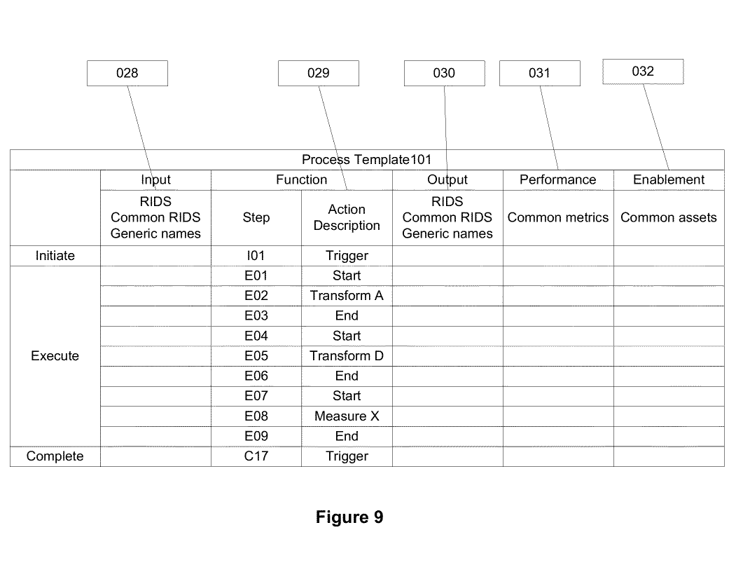

The template creation method empowers enterprises to eliminate many of the obstacles to transformation. First, the template creation method, FIG. 9, provides the standard meta-model structure that enables a common and predictable framework for any type of process thereby allowing enterprises to capture best of breed practices or timeless execution models. These models can serve as building blocks to construct any type of process. FIG. 9 illustrates this method. First, the user defines common types of rules, information, data and specifications that are to be used as input to the process steps, 028, and defines the common types of rules, information, data and specifications that are produced as output, 030. The user identifies these rules, information, data and specifications using generic names. This method allows process developers to plan for the types of input and output a process step will use without being overly specific thereby reducing the utility of the template as a common process building block. Additionally, the template creators can utilize common types of metrics, 031, and enablement assets, 032, to allow users to assess the overall effectiveness of a template. Finally, the template users build a common suite of steps, 029, for transformation and measurement so that all instances will follow the same execution logic structure.

The template method can include any number of dimensions such as hierarchical levels—supervisory and subordinate processes—within its definition. A single level process template can be adopted at numerous process locations while a hierarchical structure allows users to apply a template to a type of work as a holistic solution that can embody an entire type of work. Additionally, one template can be combined with other templates to form enterprise execution logic covering multiple dimensions. In parallel, variations of templates can be provided for the same or similar types of work so that enterprises can determine which template performs the best and why.

### The Meaning

The template method allows enterprises a method for capturing, disseminating and executing process as building blocks that can be linked together to structure work in a common and predictable fashion. The method enables enterprises to place more emphasis on what to execute instead of how.

### 6. Job Creation and Execution

### Current Constraints

As stated in the template creation method above, enterprises using state of the art transformation methods face constraints in translating desired processes into executable solutions. Converting process models to software code involves the risk of translation, the cost of development and the bottleneck of software experts.

### The Innovation

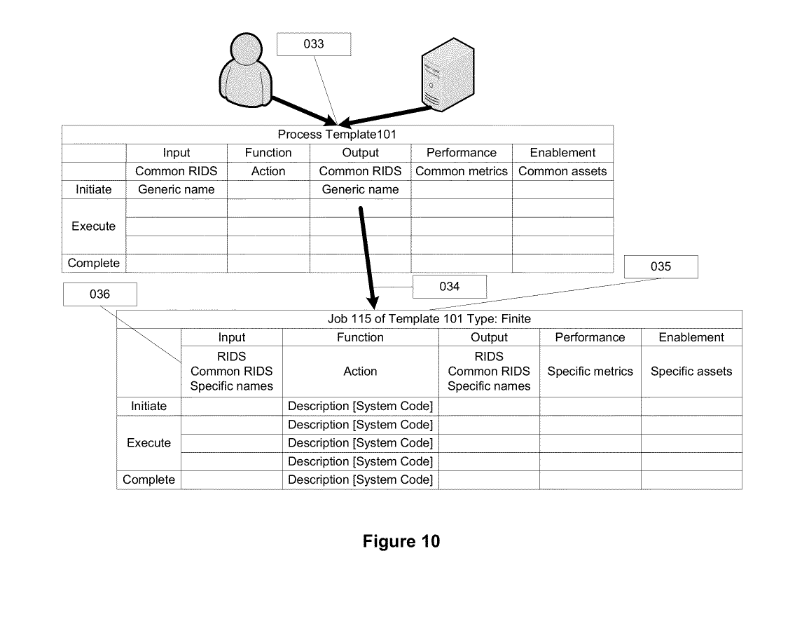

The job creation and execution method allows users to create executable jobs directly from a template as shown in FIG. 10. A person or a system, 033, can trigger the creation of a job from a named template. The generic structure of the template is loaded into a job model, 034, and at that point users apply specific values in place of the generic ones. The input and output rules, information, data and specifications are converted from generic names to specific names required for the individual job. Similarly, the initiator of the job may apply specific metrics and specific assets applicable to this job. Finally, the function action cells for each process step may receive, where applicable, system level action code in addition to the action description. This allows system or various electronic devices to receive machine coded instructions.

One more feature in the job creation method is the definition of the type of job—finite or infinite. Most jobs will be designated as a finite job since they are expected to have a clear completion time. Infinite jobs however may represent a human being or an enterprise. While both of these are clearly mortal, they have no prescribed ending date and the longer they exist, the better. Infinite jobs would supervise any number of finite jobs throughout its existence.

### The Meaning

Enterprises have a clear, crisp method to create executable jobs out of a generic process model. Templates provide reusable building blocks to create enterprise execution logic in a common and predictable fashion and the job structure allows users to drive a specific execution from those building blocks. The time, quality and cost of transforming enterprises from a strategic vision to an executable reality are dramatically improved.

### 7. Element Coding

### Current Constraint

Globally collaborative enterprises face daunting tasks in controlling the access to and the use of sensitive and proprietary information. This task is made complex by the fact that prospective collaborators can also be competitors so that enterprises require a high degree of precision in managing sensitive information. The current state of the art for controlling access attempts to provide information controls out at a point of exit which severely limits the ability of enterprises to determine the origin of the information, why it is allowable or not and to execute dissemination in an effective and efficient fashion.

### The Innovation

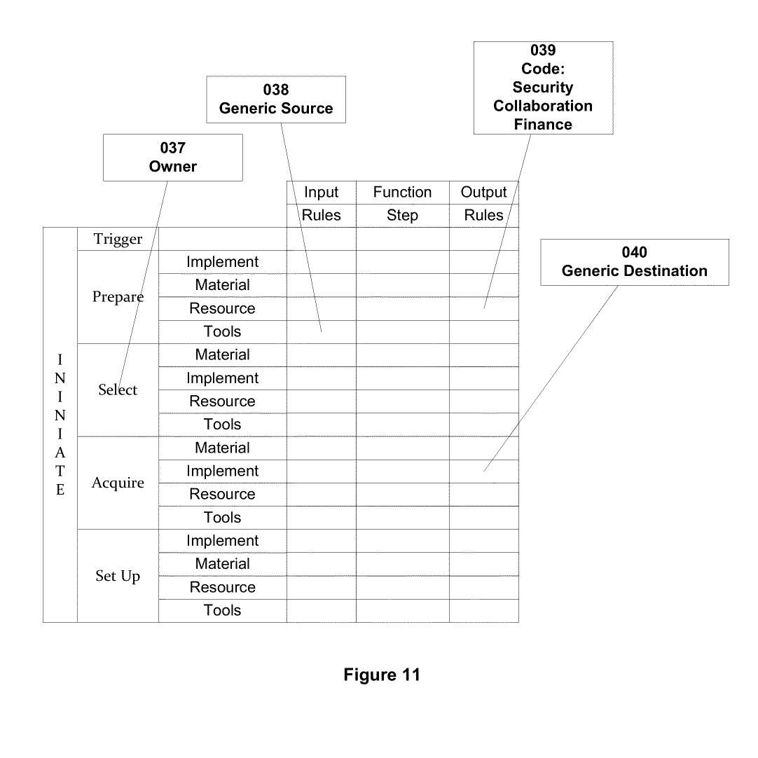

The element coding method can encode any element or collection of elements in the enterprise as shown in FIG. 11. The element coding method allows the template or job developer to assign ownership, 037, to any element such as a single cell, a column, a row, a template or job. This coding allows the assignment of responsibility to that element and can be tiered with one party responsible for a collection of elements while another is responsible for an individual element. Similarly, the coding function can assign specific controls to each element which include security, collaboration and financial codes, 039. The security code defines the level of security to which that element needs to be upheld. The collaboration code defines who the element can be shared with while the financial code defines whether there is a financial imposition for disclosing this element. Beyond these codes, the input rules, information, data and specifications, 038, can be provided a generic source in the case of a template or a specific source in the case of a job. Similarly, the output rules, information, data and specification can be provided a generic or specific destination respectively.

### The Meaning

Enterprises can assign at the point of origin the responsibility, controls, sources and destinations of all elements in the enterprise. This allows them to design efficient and effective means of controlling the distribution of execution elements.

### 8. Identification of Enterprise Elements

### Current Constraint

Almost every enterprise lacks the ability to know precisely the state of any process throughout its span of control. State of the art inventions such as dashboards provide general pictures of the status of the enterprise but fail to provide the precision to demonstrate the exact executional state of specific processes and process elements anywhere within its domain. Beyond knowing the process step, enterprises normally desire to know the exact state, location and use of any element in the enterprise. Today, state of the art tools fail to provide such capabilities.

### The Innovation

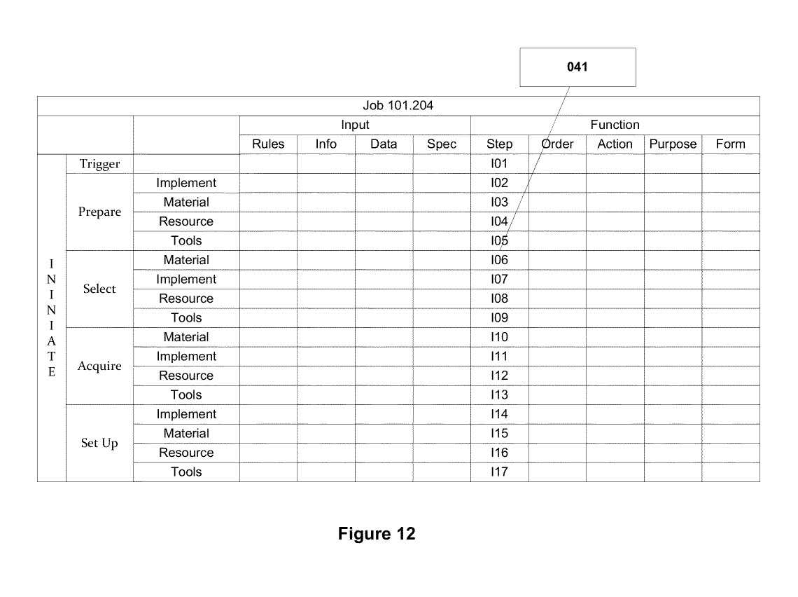

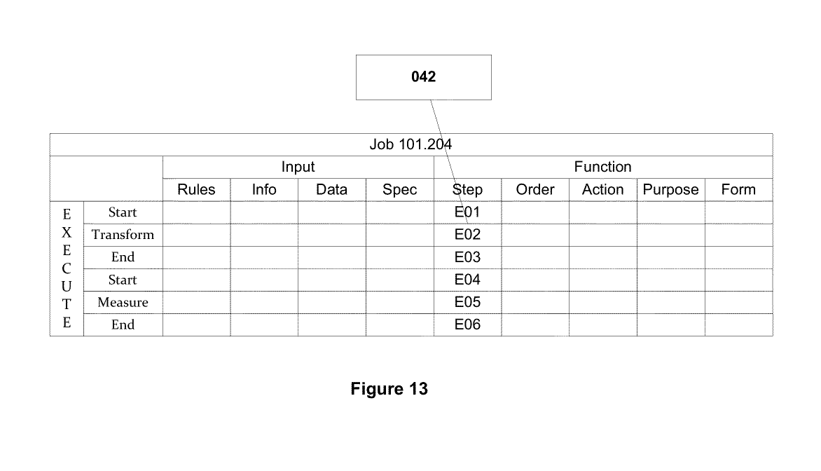

The identification of enterprise elements method provides the means to identify any process step and any element within a process at any location in the enterprise. FIG. 12 shows the method for identifying process steps in the initiate sub-process of a template or job. Each step identifier begins with an ‘I’ followed by two numeric characters therefore the specific process step can be uniquely identified within the enterprise by the template or job id and the step id. FIG. 13 shows the identification of the execute sub-process of a job. Each step identifier begins with an ‘E’ followed by two numeric characters, 042.

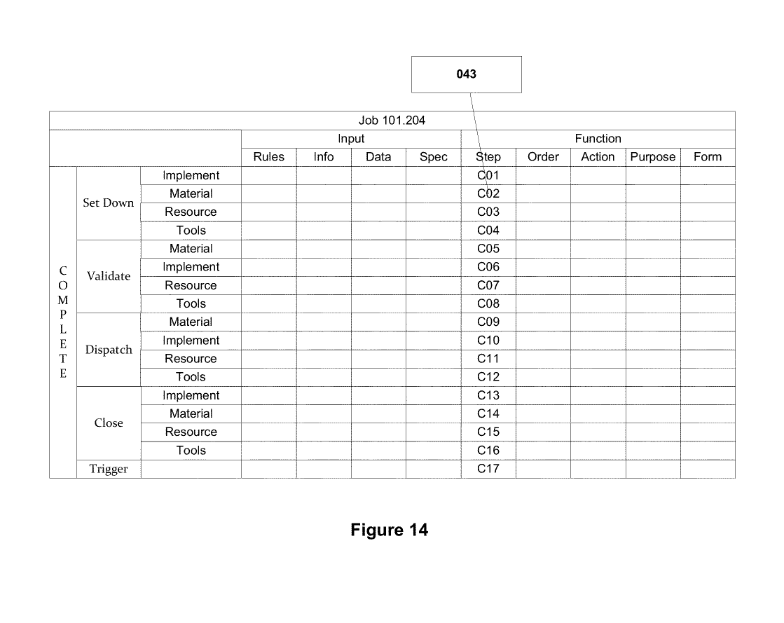

The complete sub-process step identifier, FIG. 14, begin with a ‘C’ followed by two numbers, 043. This identification scheme serves multiple purposes. First, it keeps the identification of sub-process steps discrete to ensure control over process order and ensuring quality execution. Second, it supports the linkage between supervisory and subordinate processes by ensuring that the supervisory process always creates subordinate processes out of the execute sub-process.

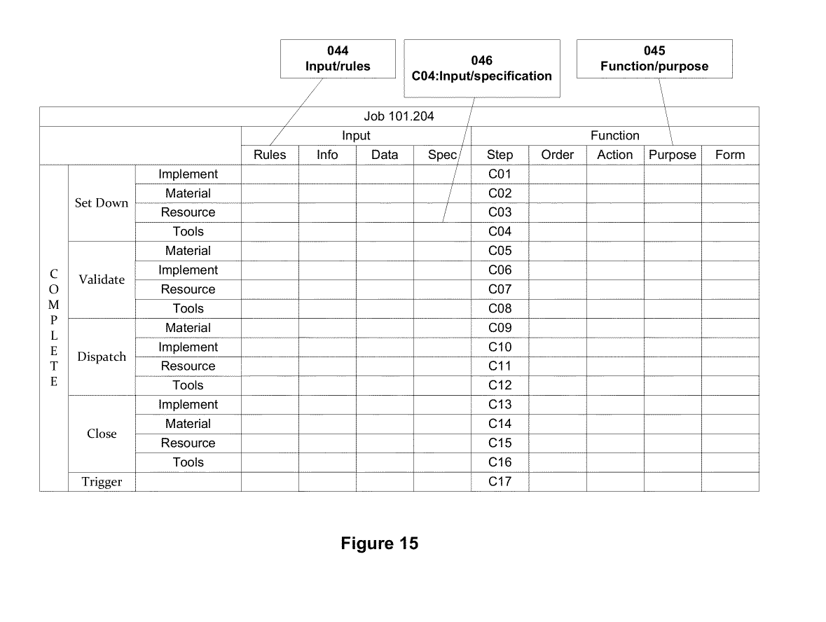

In addition to process steps, the identification method allows the direct identification of any cell or collection of cells within any process across the enterprise. FIG. 15 shows the method for identifying columns within a process. A column identifier method takes the master level identifier and combines it with the subordinate level identifier. Accordingly, 044, the rules column, is identified as Input/rules while 045, the purpose column is identified as Function/purpose. An individual cell is identified by concatenating the step identifier with the column identifier such as 046 whereby the cell is identified by the step identifier, C04, combined with the input/specification identifier. Every column and cell identifier can be concatenated with the template or job identifier to provide a unique identifier throughout the enterprise. Finally, when any of the four elements—material, implement, resource or tool is assigned to a job, this identification method allows users to view them in their current state of execution.

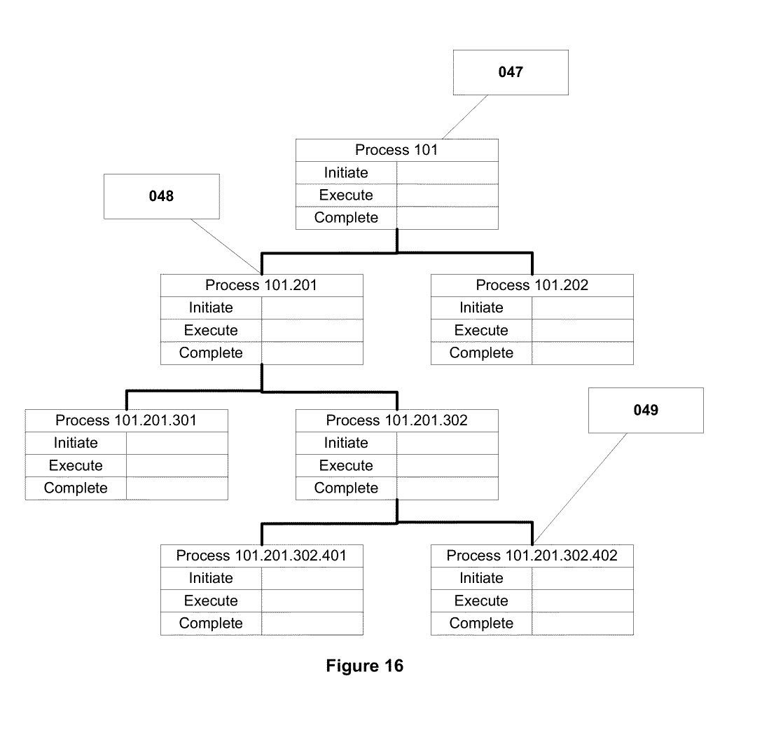

Since enterprises of any complexity execute a hierarchy of processes, full enterprise traceability must accommodate identification across hierarchies of execution. FIG. 16 shows the method of process identification across hierarchies. Every template or job has a top supervisory process that is identified as a one hundred series number, 047. Each level of subordinate process underneath is incremented by one hundred and concatenated to its supervisory process as in 048. Processes having the same supervisory parent are incremented by the last two digits as shown in 049. By this method, identification is maintained uniquely across any level or breadth of process execution in the enterprise.

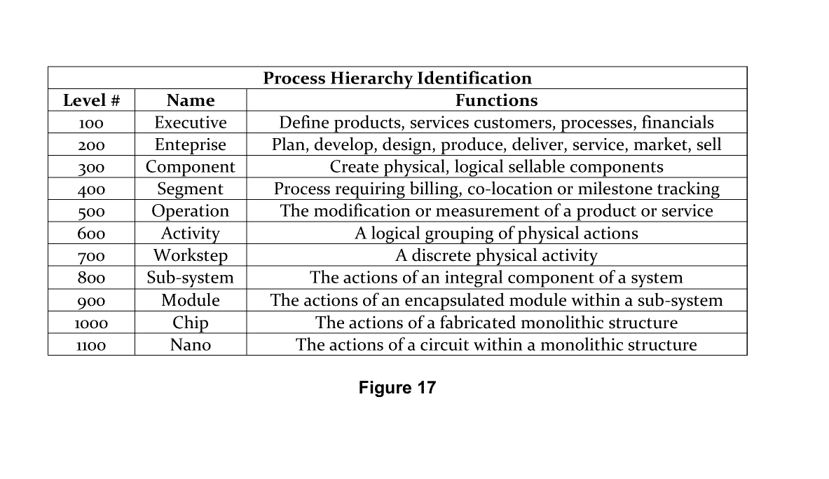

The hierarchical identification method also provides names to levels of execution as shown in FIG. 17. Most enterprises require a logical order of hierarchy and the addition of discrete names and functions to each level enables clarity of process hierarchy design and the allocation of processes within a level. Rather than applying levels of hierarchy haphazardly across the enterprise, this structure of naming and level setting by function empowers the creation of a common and predictable enterprise-wide structure—level numbers can convey the same function regardless of location or department. Intra-enterprise processes can be coordinated and seamlessly linked across enterprise disciplines.

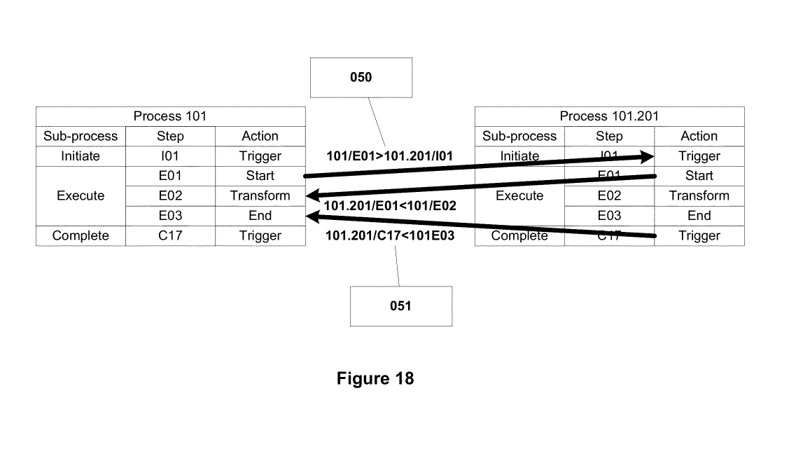

The hierarchical identification method ensures a high degree of precision in interlocking hierarchies of execution by discretely identifying the transactions between them as shown in FIG. 18. The initial transaction from the supervisory process to the subordinate process occurs from the start step in a transformation or a measurement action and goes to the trigger step of the subordinate process. This transaction, 050, is uniquely identified by concatenating the supervisory process identifier with the step identifier and linking them to the subordinate process identifier concatenated with its step identifier. When the subordinate process communicates to the supervisory process, it constructs the identifier linkage in reverse order, 051.

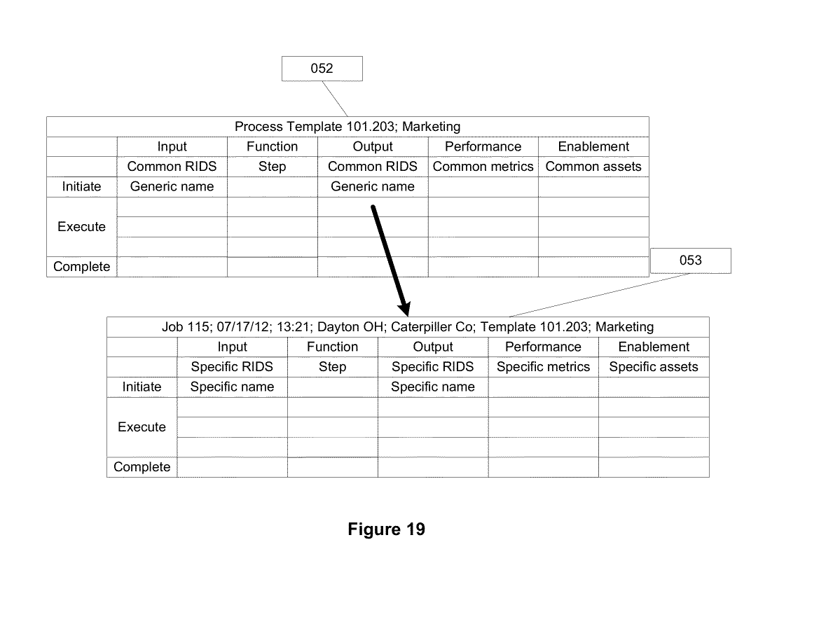

The final step in ensuring complete identification of every element in the enterprise is to ensure discrete identification of templates and jobs. FIG. 19 shows the identification method of templates and jobs and their respective relationship. The template receives a numerical identifier from its position in the enterprise execution hierarchy, but a name is appended to the numeric identifier as well, 052. Jobs that are created out of this template receive more specific identifiers in addition as shown in 053. The job creation method applies a job sequential number to the job executed under that template, attaches a date/time stamp, provides the physical and logical location of the job and adds the template identification.

### The Meaning

For the first time, enterprises have the ability to track any execution engaging any process or any element within its domain and to view its use precisely. Enterprises gain unprecedented capability to monitor, evaluate and control their activities anywhere within their domain.

### 9. Monitor, Evaluate and Control

### Current Constraints

State of the art dashboards allow enterprises a general view of the state of their execution and performance. Such dashboards however fall short in serving the needs of the enterprise in their inability to support real time, precise execution control.

### The Innovation

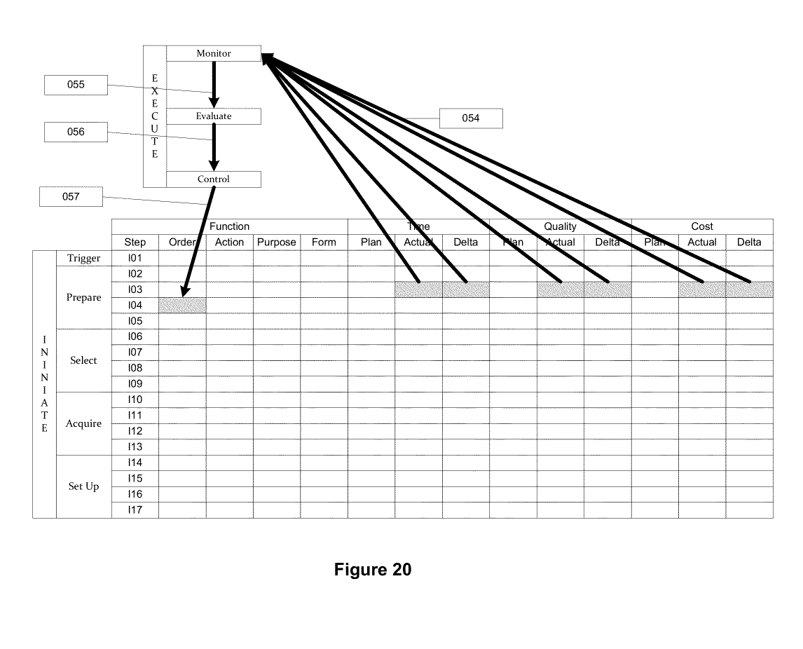

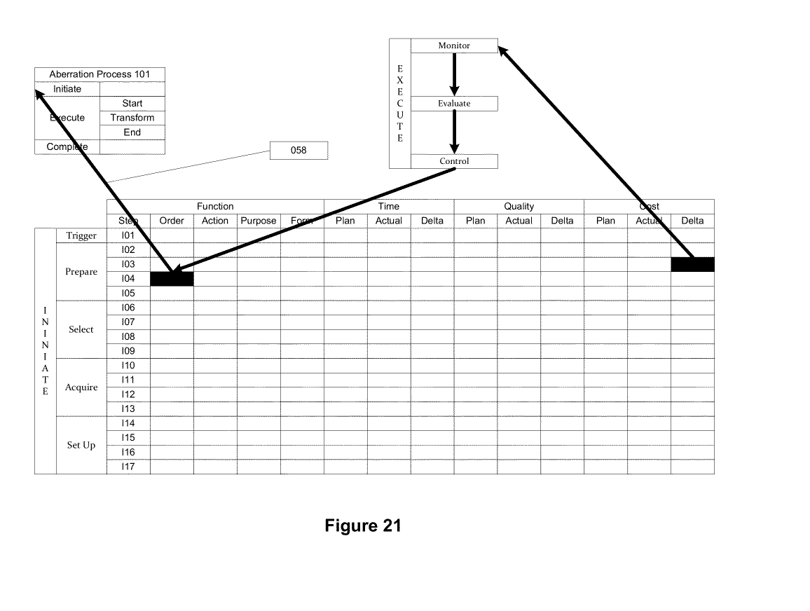

The monitor, evaluate and control method provides the ability to control any level of process at any time anywhere in the enterprise. Per FIG. 20, the monitor method employs the performance entities of a job to capture the state of execution. As 054 shows, the monitor method captures the four performance entities—time, quality, cost and scale (not shown) in their actual and delta plan-to-actual results. The monitor function passes the compiled results, 055, to the evaluate method that comprises statistical and other limit checks to determine if the absolute or relative values are inside or outside of limits. If the process is out of limits, it sends a signal to the control method to respond to the aberration, 056. The control method calculates the degree of severity or nature of the aberration and sends the corresponding signal to the step-based function order operation in the job, 057. The function order may contain embedded aberration or exception condition instructions which can halt the process or, as in the case of FIG. 21, trigger an aberration process as a response, 058.

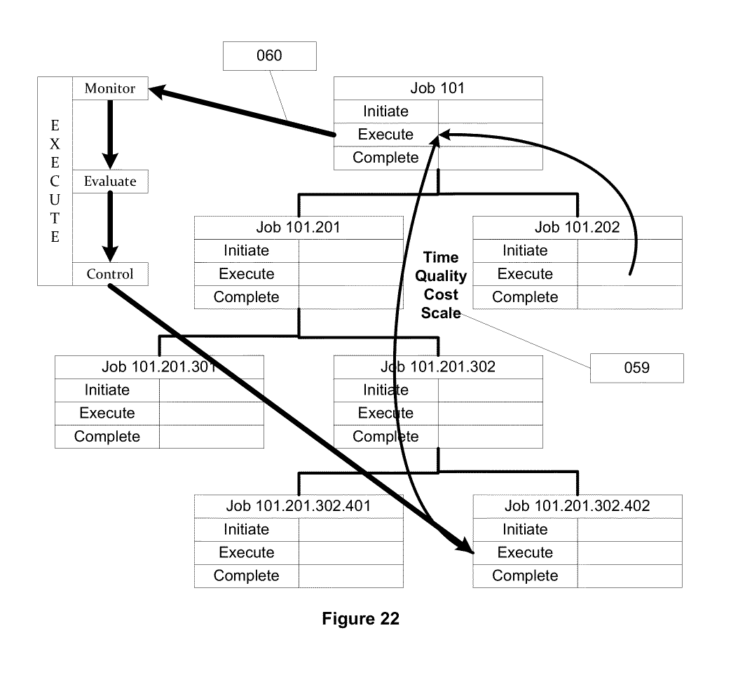

The hierarchical linkages of the architecture allow enterprises to summarize and respond to subordinate job performance as shown in FIG. 22. It can be the case where the aberrations within subordinate jobs can be within their individual process limits, but the accumulative effect of the multiple subordinate process variances can cause the supervisory job to be out of tolerance. As shown in FIG. 22, the hierarchical structure of the supervisory Job 101 allows it to accumulate the performance metrics—time, quality, cost, scale—of its subordinate processes, 059 and submits the results to the monitor, evaluate and control method, 060. If the evaluate method finds the cumulative process to be aberrational, the control method can send a signal to any appropriate subordinate process to respond to the aberration.

### The Meaning

The monitor, evaluate and control method provides the enterprise with unprecedented degrees of process monitoring and control at every level and location within the process hierarchy.

### 10. Comparative Performance Overlay

### Current Constraints

Enterprises lack common and predictable method of analyzing any and all process models or execution histories within its domain that allow complete and correct comparisons. The broad and precise process comparisons are exactly the sources of information that allow enterprises to self-assess and improve their execution, yet these are the comparisons that are lacking.

### The Innovation

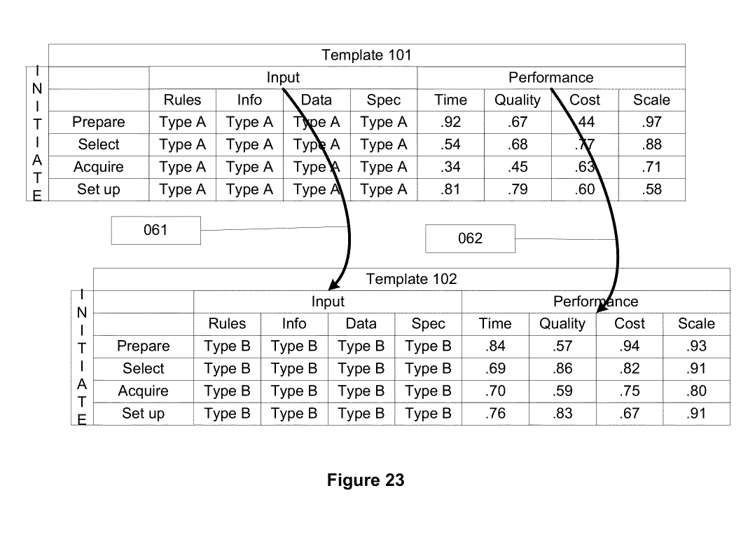

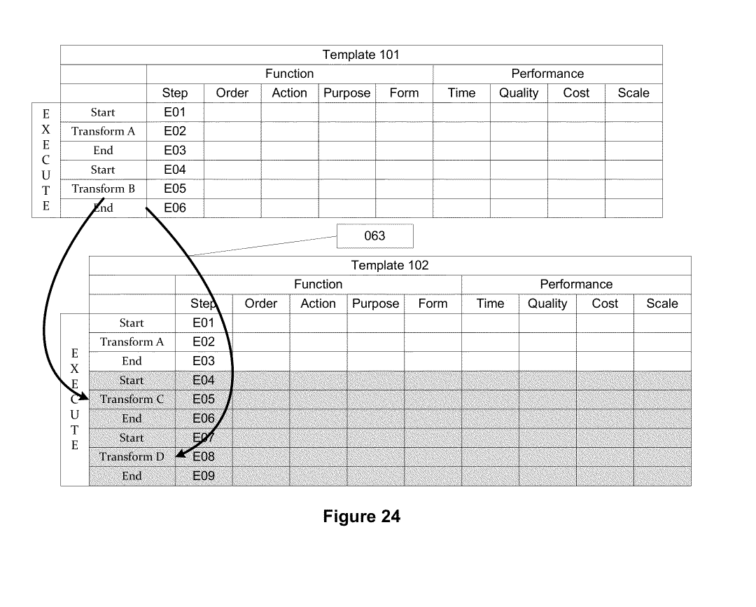

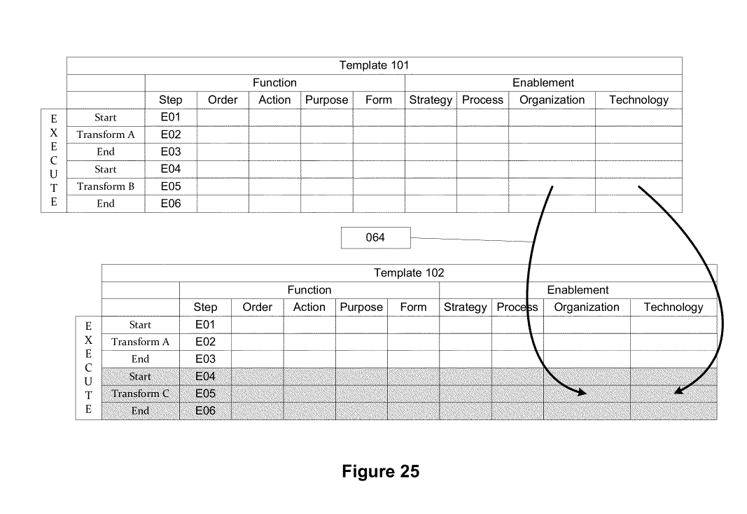

The comparative performance overlay method allows a high degree of breadth, depth and accuracy in comparing elements of the enterprise execution logic and history. The first portion of the comparative performance overlay is the ability to compare templates based on the history of jobs run against the templates, FIG. 23. Different templates can perform similar work but utilize different rules, information, data and specifications, 061. The overlay of these templates can reveal divergent performance results by time, quality, cost and scale, 062, thereby illuminating the impact of the input elements. The comparative performance overlay method can also contrast the historical job performance of templates with different process steps per FIG. 24. Note that template 102 substitutes transformation steps C and D for transformation step B in template 101, 063. This allows the overlay to capture the performance divergences that arise from the substitution of process steps. Finally, different templates may employ different enablers such as organization and technology as depicted in FIG. 25. These differences in enablers, 064, can be compared to the execution performance to determine their respective results.

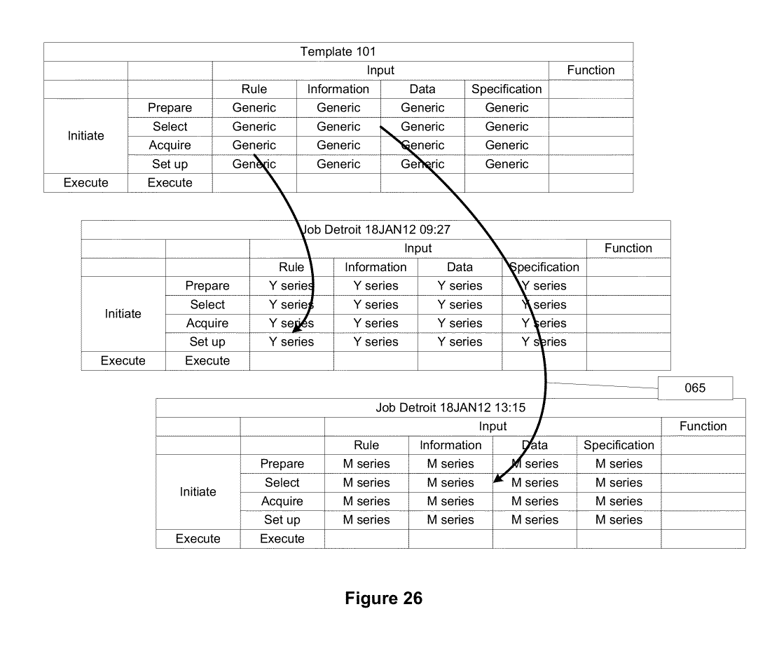

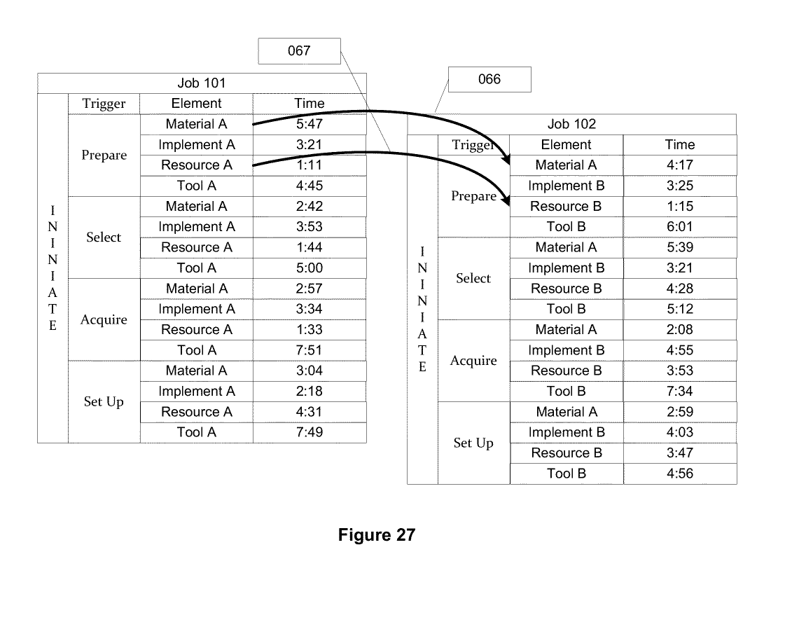

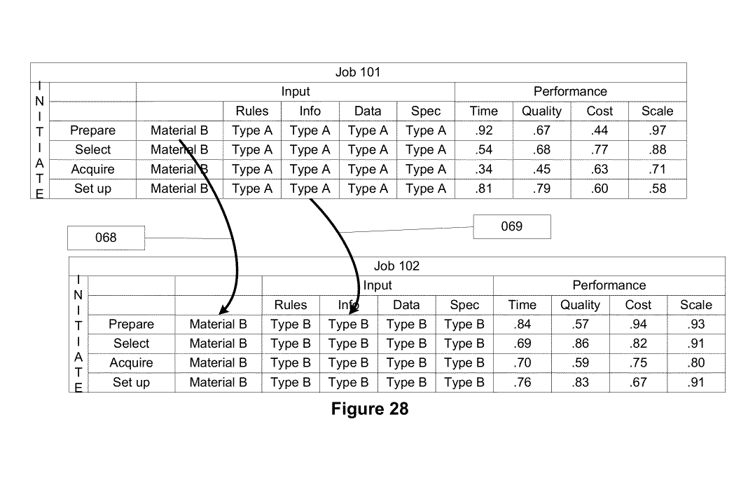

The comparative performance overlay method can track execution differences in jobs. As shown in FIG. 26, jobs utilizing the same template can employ unique rules, information, data and specifications, 065. The overlay can compare the process step performance related between these two jobs. Similarly, FIG. 27 demonstrates how different process elements—material, implement, resource or tool—can be compared. The same type of material, 066, is exposed to different process, resource and tool elements, 067, in Job 102. The performance results outcome as well as the impact on the material can be compared in the overlay. Similar to the template comparison, FIG. 28, shows how common material applied across two jobs, 068, can be related to performance by the use of different rules, information, data and specifications, 069.

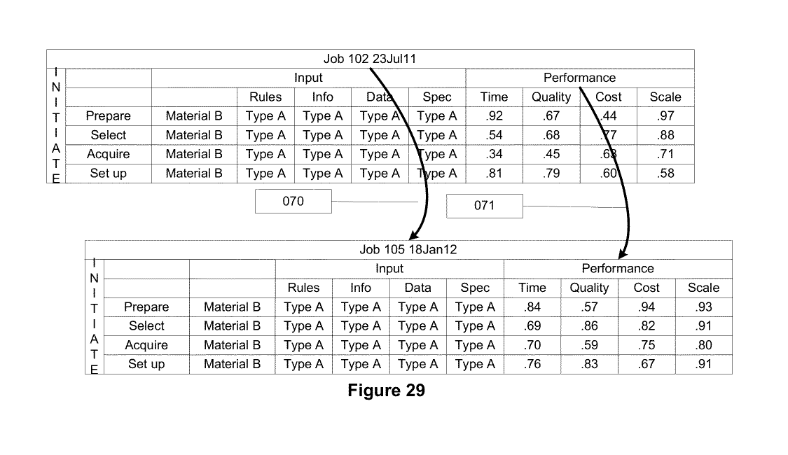

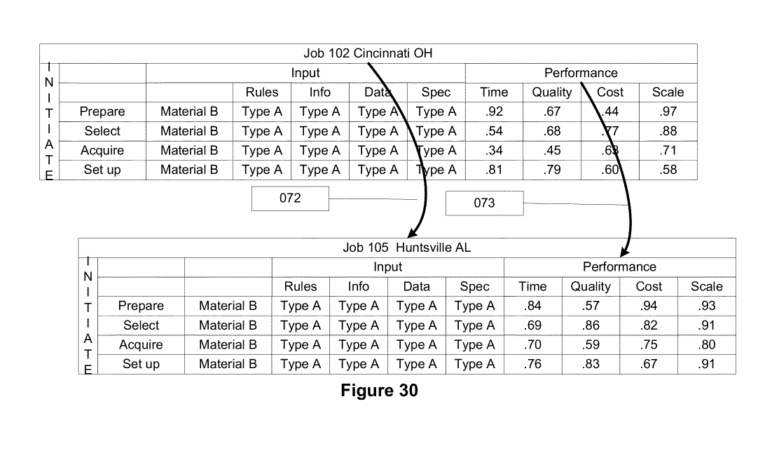

The comparative performance overlay method can analyze for the impact of time and location on templates, jobs and materials utilized in jobs. FIG. 29 shows the overlay of jobs performed by the same template in two separate time periods, 070, and compares the performance over these periods, 071. The time periods can include date, day of the week, events or age. Similarly, the same overlay method can be applied to the comparison of jobs of different time periods. Both templates and jobs can be compared by physical and logical locations per FIG. 30. The different location of job execution, 072, can be compared to the relative performance of the locations, 073. Specific process elements—material, implement, resource and tool—can be overlaid and compared for performance by time and location.

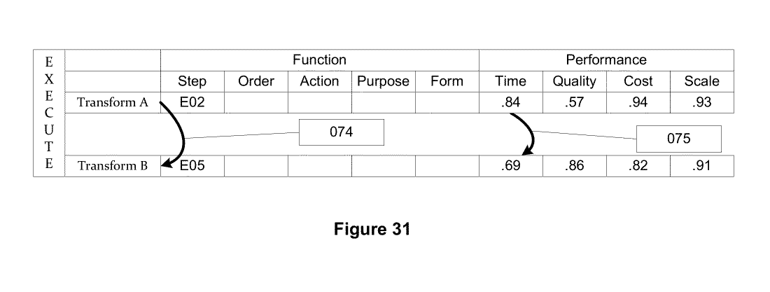

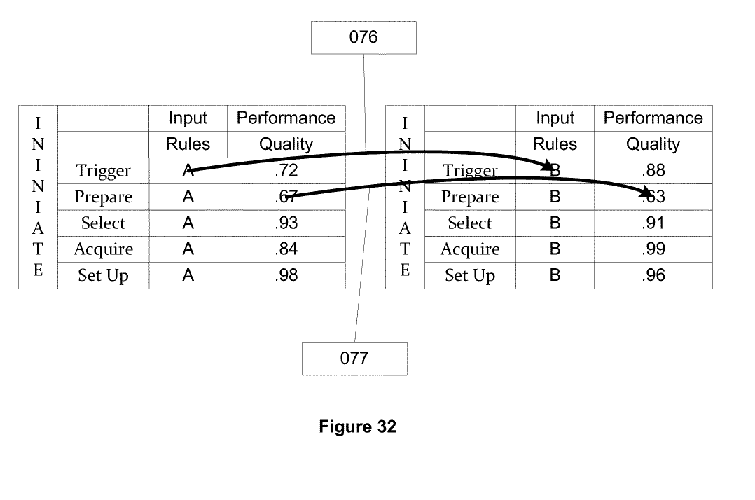

The comparative performance overlay applies to specific entities within a template or a job. FIG. 31 shows the comparison of performance of different transformation steps, 074, which yield different performance results, 075. Similarly, FIG. 32 shows how the overlay of different rules, 076, yields different performance results for the same process steps. Each overlay can be constructed using the identification of enterprise elements method, FIG. 15, and defining the targeted overlay of rows, columns or specific cells.

### The Meaning

The comparative performance overlay method provides enterprises with the power to assess any combination of execution elements anywhere within its scope and to discern their relative performance. This method allows enterprises to improve significantly their ability to assess their execution performance and institute targeted improvements.

### 11. RID Enterprise Fabric

### Current Constraint

Enterprises employ enterprise data fabric, EDF, methodologies to drive the right data to the right location at the right time. The reason for employing this method is for enterprises to avoid data request bottlenecks and propagation delays associated with wide spread requests directed to a single server location. The goal of EDF is to disseminate the required data to the locations where users need it thereby eliminating the bottlenecks and propagation delays. The EDF method however faces a number of shortcomings. First, it only specifically includes data while failing to distinguish the separate needs for information, rules and specifications and where they should be used. Second, it provides no internal mechanism for discerning at what point of execution and at what location to stage data in the proximity of the user. Third, it lacks sufficient terms of use structures to validate the proper security and disposition of data.

### The Innovation

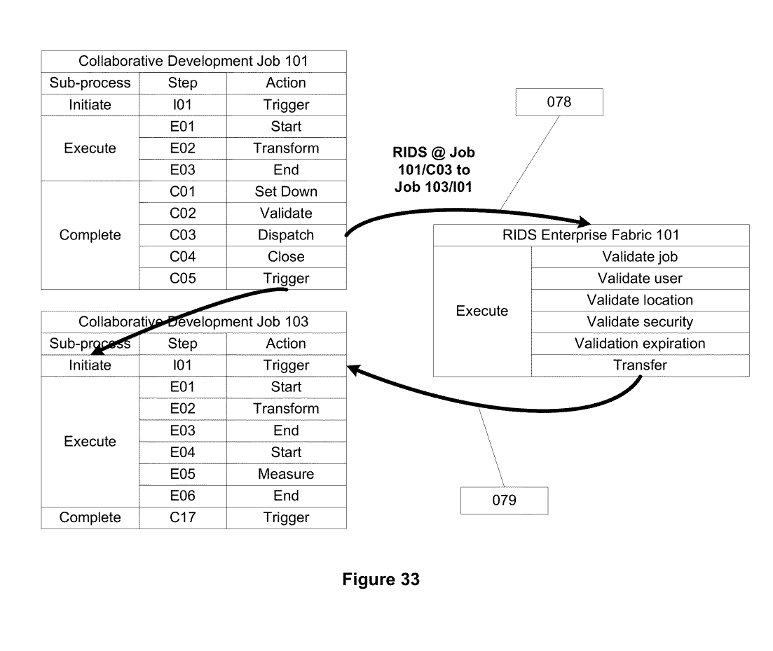

The RIDS enterprise fabric method ensures the planned and unplanned dissemination of rules, information, data and specifications to the exact process location, time and job. The planned exchanges can support a wide variety of scenarios. FIG. 33 shows the planned method for exchanging rules, information data and specifications between two sequential processes. The collaborative development job 101 transfers its rules, information, data and specifications to Job 103 after the completion of its work at the C04 complete dispatch operation, 078. The complete dispatch operation triggers an autonomous RIDS Enterprise Fabric job to disseminate the rules, information, data and specifications to the subsequent job. This dispatch is identified by applying the specific job identifier and the step identifier, 079 and the complete trigger step of Job 101 then triggers the initiate trigger step of Job 103.

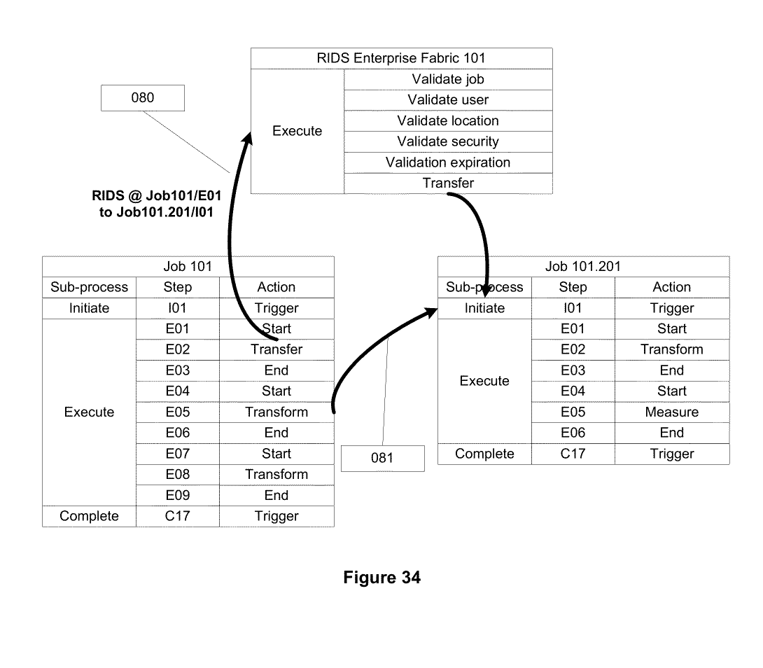

A second variant of the planned transfer of rules, information, data and specifications is provided by FIG. 34. This scenario shows the transfer of rules, information, data and specifications to a subordinate process in a separate location. In this example, the predefined transfer, 080, occurs at step E02 of the supervisory process ensuring that the rules, information, data and specifications will be sent to the right input locations before the initiation of the subordinate process, job 101.201, by the supervisory process, 081, at E05.

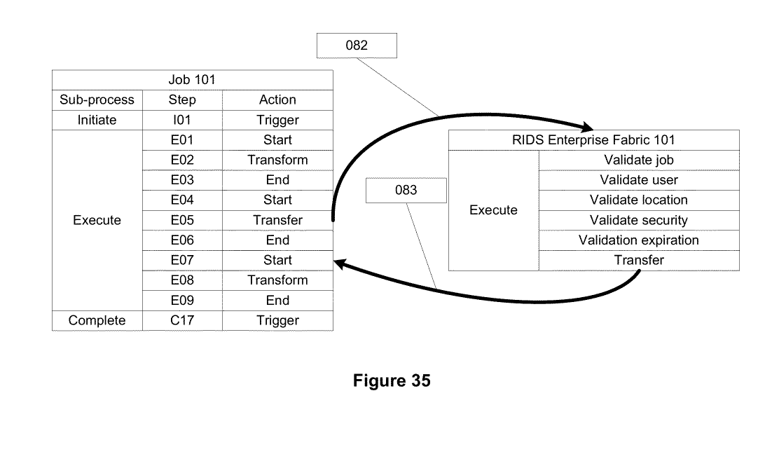

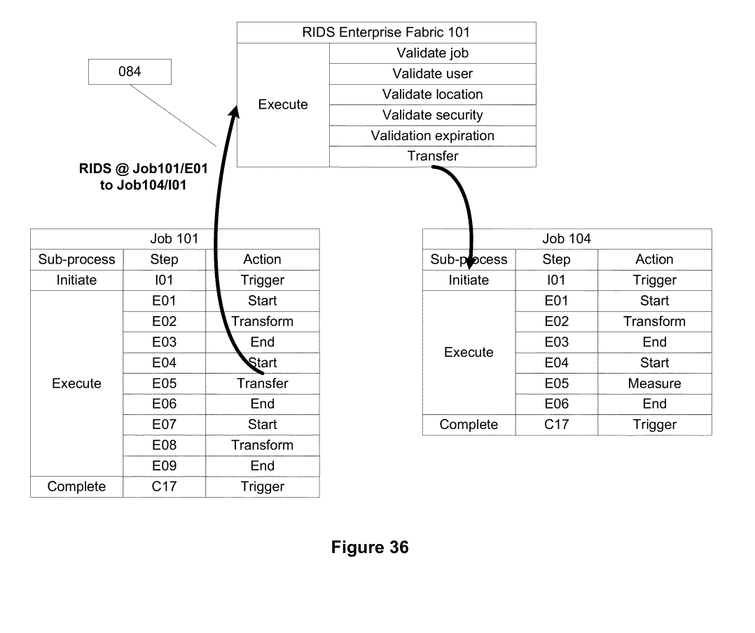

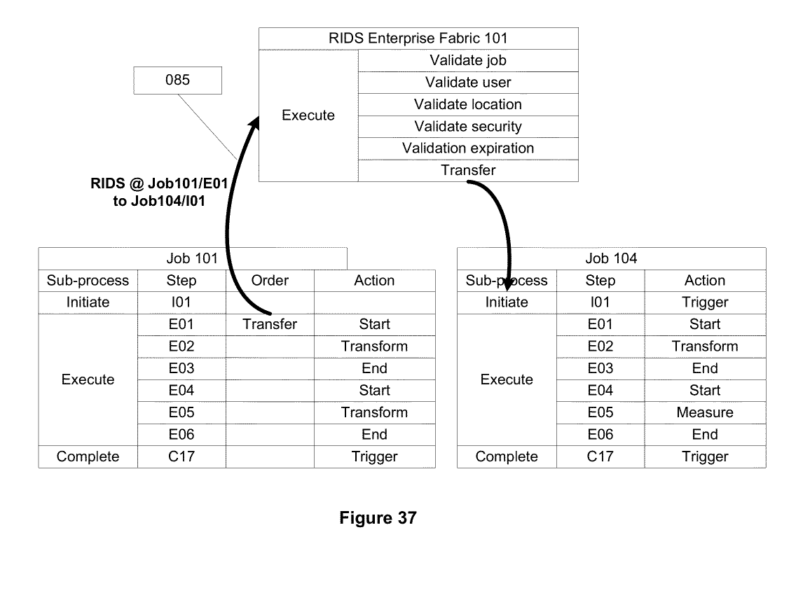

Cases may occur where the planned relocation of an activity occurs in the middle of a job which is depicted in FIG. 35. The transfer of rules, information, data and specifications occurs in this example at E05 before the next transformation step, E08. The E05 transfer step, 082, creates a RIDS Enterprise Fabric job to exchange the key elements to the new location ahead of the next execution step, 083. Alternatively, FIG. 36 provides an example where a separate job, Job 104, routinely requires rules, information, data and or specifications from Job 101. This type of scenario was presented in FIG. 8 under the resolution of massively parallel process requirements. Through its actions, Job 101 creates rules, information, data and specifications at step E02 needed by Job 104. Job 101 therefore initiates a RIDS Enterprise Fabric job, 084, at step E05, to supply the necessary elements to Job 104.

Not all transfer needs however can be planned in advance and therefore provisions are provided to support ad hoc transfers as shown in FIG. 37. In this example, an ad hoc request is made to transfer rules, information, data and specifications from Job 101 to Job 104. An exception process is triggered at Job 101 step E01 to initiate a RIDS Enterprise Fabric job, 085, to dispatch the required elements to Job 104.

There may be instances however when one process may have to send rules, information, data and specifications to another job on an ad hoc basis. In this case, the activities shown in FIG. 37 show how this is accomplished. The function order method can contain a trigger to a RIDS Enterprise Fabric exchange template to create and exchange job, 085. This exchange job transfers the rules, information, data and specifications to the correct location in the target job.

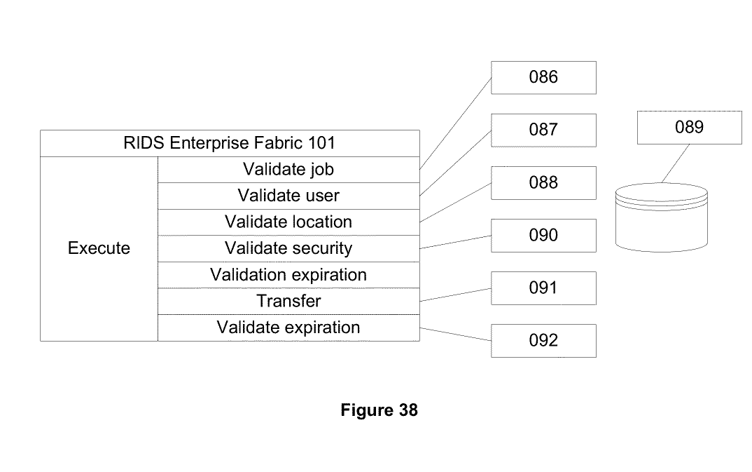

The RIDS Enterprise Fabric template provides a set of operations that allow the proper execution of a transfer when an exchange job is created as shown in FIG. 38. The first operation, 086, validates the target job, the required rules, information, data and or specifications needed and the exact process step or steps where these are required. The next operation, 087, validates the user against the codes used for each the elements such as the collaboration code and the financial code to ascertain the degree of dissemination permitted. The third operation, 088, validates the physical and logical location to transfer the elements to. For example, the physical location to store the elements, 089, may not be the same as the logical location of the activity. The next operation, 090, validates the security requirement of the elements using the security codes. This operation validates whether the job, the user and location fit the security needs and sets an expiration date for storing the elements remotely. When everything has been validated, the RIDS Enterprise Fabric job transfers the elements to the target job using the job id and cell identifiers, 091. When the expiration date is reached, the expiration operation validates that the elements have been purged, 092.

### The Meaning

Enterprises now have the means to disseminate the right rules, information, data and specifications to the right location at the right moment with security for the right amount of time.

### 12. Trigger Creation Method

### Current Constraint

Enterprises gain control over their activities when they possess common and predictable processes to trigger activities in a complete and correct fashion. The industry however lacks formal methods and tools for providing enterprises with such tools.

### The Innovation

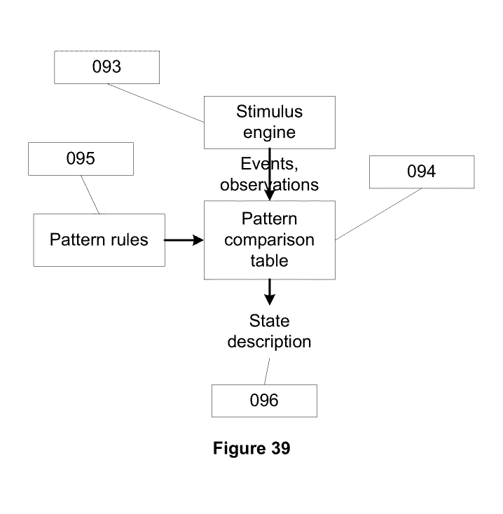

The trigger creation method provides a structured set of methods and tools to enable a common and predictable method for triggering jobs. The first element is the method to capture and process stimuli as shown in FIG. 39. The first method of stimulus processing is the activation of a stimulus engine, 093, which is designed by the user to capture defined events and observations and place them in a pattern comparison table, 094. When the pattern comparison table event and observation units reach sufficient quantity or consistency, the stimulus engine calls a set of pattern rules to overlay the inputs, 095. If the input data set fits the pattern rules within defined statistical limits, the stimulus engine dispatches a state description, 096.

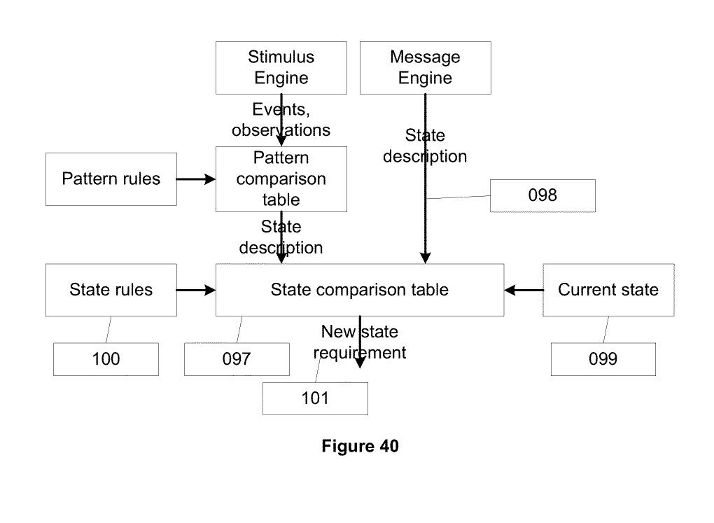

The second function of the trigger creation method is the message engine which determines whether a new state exists. The message engine, FIG. 40, provides a state comparison table, 097, which can receive the state description created by the stimulus engine. Alternatively, the message engine can be the recipient of an autonomous state description from an external source, 098, and send it to the state comparison table. In either case, the inputted state description is placed in the state comparison table that lays out its attributes. The message engine then summons the current state, 099, and overlays the inputted in the state comparison table. The state rules, 100, are accessed to determine if the inputted state is significantly different from the current state and if it is, the new state requirement is exported by the message engine, 101.

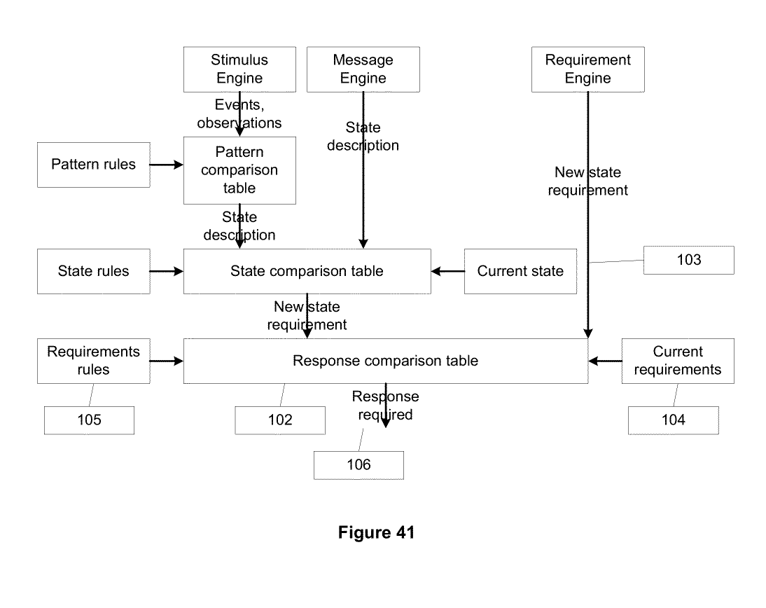

The next function of the trigger creation method is to determine if a response is required by the existence of a new state. FIG. 41 shows the requirements engine which provides a response comparison table, 102, that performs analysis of whether a response is required. The response comparison table can receive the input of a new state requirement from the message engine or the requirements engine facilitates the insert of an autonomous new state requirement from an exterior source to the response comparison table, 103. The requirements engine overlays the new state requirement with the current requirements, 104, and applies the requirements rules, 105. If the new requirements exceed the limits of the existing requirements, the requirements engine then generates and dispatches a response required output, 106.

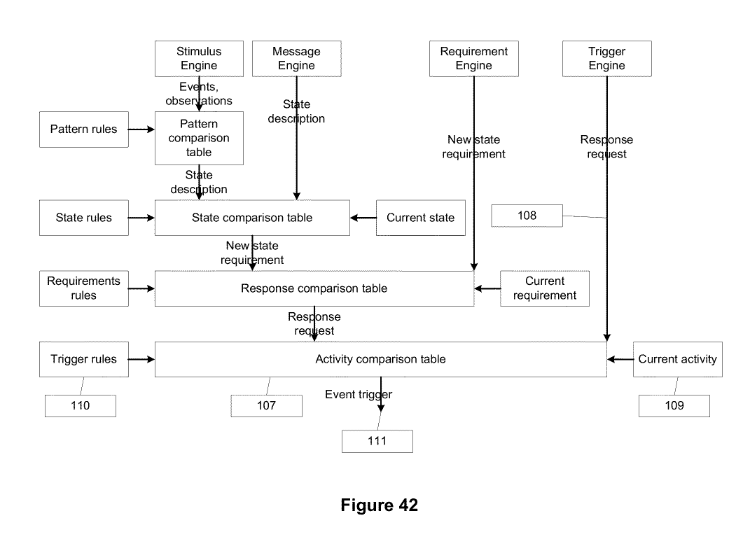

The final need for the trigger creation method is the ability to generate a trigger. The trigger engine, FIG. 42, provides an activity comparison table, 107, and which receives response requests from the requirement engine. The trigger engine however can receive response requests directly from autonomous external sources, 108, and send to the activity comparison table. The required activity is overlaid by the current activity, 109, and compared using the trigger rules, no, to determine if the required activity significantly diverges from the current activity. If the differences are significant, the trigger engine can dispatch an event trigger, 111.

### The Meaning

The trigger creation method performs an important function for creating jobs from templates as shown in FIG. 10. It offers a methodology that can be employed manually by a person or automatically by a system and ensure that new jobs are created in a common and predictable method.

What is claimed is:

1. A method of systematically performing hierarchical process control, the method comprising:
performing a process element control operation, wherein the process element control operation comprises the addition of elements to the initiate, execute and complete sub-processes;
performing a process order operation, wherein the process order operation comprises controlling the execution order of processes and sub-processes;
performing a sub-process operation, wherein the sub-process operation comprises the initiation, execution and completion of sub-processes;
performing an identification operation, wherein the identification operation comprises the identification of process step, elements, hierarchies and interactions; and
performing a process control operation, wherein the process control operation comprises monitoring, evaluating and controlling processes across hierarchies;

2. A method of claim 1 of systematically performing the initiate operation, the method comprising:
performing the initiate prepare operation, wherein the initiate prepare operation comprises prepare process, prepare implement, prepare resource and prepare tools;
performing the initiate select operation, wherein the initiate select operation comprises select process, select implement, select resource and select tools;
performing the initiate acquire operation, wherein the initiate acquire operation comprises acquire implement, acquire material, acquire resource and acquire tools; and
performing the initiate set up operation, wherein the initiate set up operation comprises set up implement, set up material, set up resources and set up tools.

3. A method of claim 1 of systematically performing the complete operation, the method comprising:
performing the complete set down operation, wherein the complete set down operation comprises set down implement, set down material, set down resource and set down tools;
performing the complete validate operation, wherein the complete validate operation comprises validate implement, validate material, validate resource and validate tools;
performing the complete dispatch operation, wherein the complete dispatch operation comprises dispatch implement, dispatch material, dispatch resource and dispatch tools; and
performing the complete close operation, wherein the complete close operation comprises close implement, close material, close resources and close tools.

4. A method of claim 1 of systematically performing the execute operation, the method comprising:
performing a start operation, wherein the start operation comprises logging the implement, material, resource, tool, the date, time and location; and
performing an end operation, wherein the end operation comprises logging the implement, material, resource, tool, the date, time and location

5. A method of claim 1 of systematically performing a function order process, the function order method comprising;
performing a step relationship operation, wherein the step relationship operation comprises start and finish relationships with other steps;
performing a sub-process operation, wherein the sub-process operation comprises constraining start and finish relationships within each initiate, execute and complete boundary; and
performing a conditional branching operation, wherein the conditional branching operation defines conditions that require branching to predefined processes.

6. A method of claim 1 of systematically performing a subordinate process, the subordinate process method comprising:
performing the trigger process operation, wherein the trigger process comprises the execute start operation sending a trigger to a subordinate initiate trigger function;
performing the start transform operation, wherein the execute start of the subordinate process comprises sending a trigger to an execute transform step or an execute measure step in the supervisory process;
performing the complete trigger operation, wherein the complete trigger operation of the subordinate process comprises sending a trigger to an execute end function in the supervisory process;
performing multiple subordinate processes, wherein the subordinate processes can be created with each start transform end or start measure end set of the supervisory process;
performing subordinate process order operation, wherein the subordinate process order operation of the supervisory process comprises controlling the sequential order of the subordinate processes through its function order instructions; and
performing parallel process operation, wherein the parallel process operation comprises dispatching discrete and defined elements from one process to an explicit location in another process.

7. A method of claim 1 of systematically performing element coding, the element coding comprising:
performing an ownership operation, wherein the ownership operation comprises applying an owner of any element or collection of elements within a template or a job;
performing a code operation, wherein the coding operation comprises applying a security, collaboration or financial code to any element of a template or a job;
performing a source operation, wherein the source operation comprises defining a generic source for input rules, information, data and specifications; and
performing a destination operation, wherein the destination operation comprises defining a generic destination for the output rules, information, data and specifications.

8. A method of claim 1 of systematically performing an identification operation, the identification operation comprising:
performing a step identification operation, wherein the step identification operation comprises step identifiers as follows where ‘n’ is a numeric digit:
Inn for initiate
Enn for execute
Cnn for Complete;
performing a column naming operation, wherein the column identification operation comprises concatenating the column headers as follows:
top level header/second level header;
performing a cell naming identification operation, wherein the cell identification operation comprises cell identifiers as follows:
step identifier: column header;
performing a hierarchical process identification operation, wherein the hierarchical process identification operation comprises increments of 100 for each process level starting from the highest;
performing a horizontal process identification operation, wherein the horizontal process identification operation comprises incrementing the hierarchical identifier by one for each subordinate process under the same supervisory process;
performing a hierarchical naming operation, wherein the hierarchical naming operation comprises a name associated with each process level and a description of the level function as provided below:

| Level # | Name | Functions |
|---|---|---|
| 100 | Executive | Define products, services customers, processes, |
| | | financials |
| 200 | Enteprise | Plan, develop, design, produce, deliver, service, |
| | | market, sell |
| 300 | Component | Create physical, logical sellable components |
| 400 | Segment | Process requiring billing, co-location or |
| | | milestone tracking |
| 500 | Operation | The modification or measurement of a product |
| | | or service |
| 600 | Activity | A logical grouping of physical actions |
| 700 | Workstep | A discrete physical activity |
| 800 | Sub-system | The actions of an integral component of a system |
| 900 | Module | The actions of an encapsulated module within a |
| | | sub-system |
| 1000 | Chip | The actions of a fabricated monolithic structure |
| 1100 | Nano | The actions of a circuit within a monolithic |
| | | structure; |

performing a process linkage operation, wherein a process linkage operation comprises the following identification of triggers between supervisory and subordinate processes:
supervisory_process_identifier/step_identifier>subordinate_process_identifier/step_identifier;
subordinate_process_identifier/step_identifier>supervisory_process_identifier/step_identifier;
performing a template naming operation, wherein the template naming operation comprises attaching a name for the template to the templates numeric identifier; and
performing a job identification operation, wherein the job identifier operation comprises applying ‘job’, a sequential job number, the template name, a date/time/age and a physical/logical location of the job.

9. A method of claim 1 of systematically performing a process control operation, the process control operation comprising:
performing a monitoring operation, wherein the monitoring operation comprises accumulating the plan, actual and delta performance elements—time, quality, cost, scale—from each process step and accumulating them;
performing an evaluate operation, wherein the evaluate operation comprises comparing the plan, actual and delta performance conditions against allowable deviations;
performing a control operation, wherein the control operation comprises responding to deviation conditions by one or more of the following:
halting the process step; and
selecting a function order embedded aberration response template;
performing the summation reporting operation, wherein the summation reporting comprises the summation of the performance results of subordinate processes to supervisory processes; and
performing a subordinate process control operation, wherein the subordinate process control operation comprises directing a control command to a subordinate process based on the evaluation of the supervisory process.

10. A method of systematically performing process standardization, the process standardization method comprising;
performing a template creation method, wherein the template creation method comprises defining a process method within a meta-model; and
performing a job creation method, wherein the job creation method comprises defining and executing a job based on a template.

11. A method of claim 10 systematically performing template creation, the template creation method comprising:
performing a process definition operation, wherein the process definition operation comprises defining every step of the initiate, execute and complete sub-processes;
performing a generic naming operation, wherein the generic naming operation comprises inserting generic names for common input and output rules, information, data and specifications;
performing a common metrics operation, wherein the common metrics operation comprises inserting definitions of the process performance measurements; and
performing a common enablement operation, wherein the common enablement operation comprises inserting definition of the process enablement assets.

12. A method of claim 10 systematically performing job execution, the job execution method comprising:
performing a template selection operation, wherein the template selection process comprises a person or a system initiating a job from a chosen template;
performing a job type operation, wherein the job type operation comprises the selection of a finite or an infinite job type;
performing a values operation, wherein the values operation comprises applying specific values for input and output rules, information, data and specifications;
performing an action operation, wherein the action operation comprises the appending of a system code to the function action description;
performing a metrics operation, wherein the metrics operation comprises inserting specific metrics for the job; and
performing an enablement operation, wherein the enablement operation comprises inserting specific assets for the enablement.

13. A method of systematically performing process comparative analysis, the process comparative analysis comprising the overlay of various elements of templates and jobs.

14. A method claim 13 of systematically performing template overlay analysis, the template overlay analysis comprising:
performing input overlay analysis, wherein the input overlay analysis comprises comparing the performance of templates with different types of input rules, information, data and specifications;
performing step overlay analysis, wherein the step overlay analysis comprises comparing the performance of templates with different types of process steps; and
performing enabler overlay analysis, wherein the enabler overlay analysis comprises comparing the performance of templates with different types of enablers.

15. A method of claim 13 of systematically performing job overlay analysis, the job overlay analysis comprising:
performing input overlay analysis, wherein the input overlay analysis comprises comparing the performance of jobs with different specific input rules, information, data and specifications;
performing process step overlay analysis, wherein the process step overlay analysis comprises comparing the performance of jobs with different process steps;
performing process enabler overlay analysis, wherein the process enabler overlay analysis comprises comparing the performance of jobs with different enablers; and
performing element overlay analysis, wherein the element overlay analysis comprises comparing the performance of jobs with different implement, material, resource and tool elements.

16. A method of claim 13 of systematically performing element overlay analysis, the element overlay analysis comprising:
performing a material overlay analysis, wherein the material overlay analysis comprises comparing the performance of material against different templates and jobs;
performing an implement overlay analysis, wherein the implement overlay analysis comprises comparing the performance of implements against different templates and jobs;
performing a resource overlay analysis, wherein the resource overlay analysis comprises comparing the performance of resources against different templates and jobs; and
performing a tool overlay analysis, wherein the tool overlay analysis comprises comparing the performance of tools against templates and jobs.

17. A method of claim 13 of systematically performing time overlay analysis, the time overlay analysis comprising:
performing a template overlay analysis, wherein the template overlay analysis compares the performance of templates by date, day of the week, events and age;
performing a job overlay analysis, wherein the job overlay analysis compares the performance of jobs by date, day of the week, events and age;
performing an element overlay analysis, wherein the element overlay analysis compares the performance of material, implement, resource and tool by date, day of the week, events and age; and
performing a location overlay analysis, wherein the location overlay analysis comprises comparing the performance of physical and logical locations by date, day of the week, events and age.

18. A method of claim 13 of systematically performing location overlay analysis, the location overlay analysis comprising:
performing a template overlay analysis, wherein the template overlay analysis comprises comparing template performance by physical and logical location;
performing a job overlay analysis, wherein the job overlay analysis comprises comparing job performance by physical and logical location; and
performing an element overlay analysis, wherein the element overlay analysis comprises comparing implement, material, resource and tool performance by physical and logical location.

19. A method of claim 13 of systematically performing combinational overlay analysis, the combinational overlay analysis comprising comparing any columns, rows or cells of templates or jobs by performance.

20. A method of systematically performing enterprise fabric management on data, information, rules and specification, the fabric manager comprising:
performing a planned transfer operation, wherein the planned transfer operation comprises dispatching rules, information, data and specifications to a destination based on an expected use at another site;
performing an on-demand transfer operation, wherein the on-demand transfer operation comprises dispatching rules, information, data and specifications to a destination based on an unexpected use at another site; and
performing a verification operation, wherein the verification operation comprises validating all transfer elements and executing the transfer.

21. A method of claim 20 of systematically performing a planned transfer operation, the planned transfer operation comprising:
performing a next job transfer operation, wherein the next job transfer operation comprises creating a transfer job from the RIDS Enterprise Fabric Engine for the next job at the complete dispatch operation;
performing a subordinate job transfer operation, wherein the subordinate job transfer operation comprises creating a transfer job from the RIDS Enterprise Fabric Engine at the point of subordinate job initiation;
performing a same job transfer operation, wherein the same job transfer operation comprises creating a transfer job from the RIDS Enterprise Fabric Engine at an execute transform step; and
performing a separate job transfer operation, wherein the separate job transfer operation, wherein the separate job transfer operation comprises creating a transfer job from the RIDS Enterprise Fabric Engine to another job as an execute transform step.

22. A method of claim 20 of systematically performing an unplanned transfer operation, the unplanned operation comprising;
performing the ad hoc transfer operation, wherein the ad hoc transfer operation comprises creating a transfer job from the RIDS Enterprise Fabric Engine as a function order exception process at the current process step.

23. A method of claim 20 of systematically performing the RIDS Enterprise Fabric, the RIDS Enterprise Fabric comprising:
performing a job validation operation, the job validation operation comprising verifying the rules, information, data and specifications required for the target job;
performing a user validation operation, the user validation operation comprising verifying the collaboration and financial rules to applying to the target job users;
performing a location validation operation, the location validation operation comprising verifying the physical and logical location of the target job;
performing a security validation operation, the security validation operation comprising verifying the security level requirements of the target job, user and location based on the coded security rules;
performing an expiration operation, the expiration operation comprising verifying the storage expiration time of the transferred rules, information, data and specifications;
performing a transfer operation, the transfer operation comprising the actual transfer of the rules, information, data and specifications to the designated job, user and location; and
performing an expiration operation, the expiration operation comprising the verification that the rules, information, data and specifications are removed at the expiration time.

24. A method of systematically performing a trigger creation operation, the trigger creation operation comprising stimulus, message, response and trigger operations.

25. A method claim 24 of systematically performing a stimulus operation, the stimulus operation comprising:
performing a stimulus operation, wherein the stimulus operation comprises dispatching predefined events and observations to a pattern comparison table;
performing a patterns overlay operation, wherein the patterns overlay comprises overlaying stored pattern rules on the comparison table data;
performing a state operation wherein the state operation comprises defining the existence of a state where the data matches the pattern rules; and
performing a dispatch operation, wherein the dispatch operation comprises sending the state information to the message operation.

26. A method of claim 24 of systematically performing a message operation, the message operation comprising:
performing a receive state operation, wherein the receive state operation comprises dispatching a state description from a stimulus operation or an external source;
performing a current state operation, wherein the current state operation comprises placing the current known state on a state comparison table;
performing a patterns overlay operation, wherein the patterns overlay operation comprises overlaying the received state on the current state table;
performing a state rules operation, wherein the state rules operation comprises defining the existence of a new state where the overlays show significant deviation; and
performing a dispatch operation, wherein the dispatch operation comprises sending the new state requirement to a requirement operation.

27. A method of claim 24 of systematically performing a requirement operation, the requirement operation comprising:
performing a receive new state requirement operation, wherein the receive new state requirement operation comprises accepting a new state requirement from a message operation or an external source;
performing a current requirements operation, wherein the current requirements operation comprises placing the current known requirements on a requirements comparison table;
performing a requirement overlay operation, wherein the requirement overlay operation comprises overlaying the new state requirement on the current requirement on the requirement comparison table;
performing a requirement rules operation, wherein the requirement rules operation comprises defining the existence of a new response where the overlays show significant divergence; and
performing a dispatch operation, wherein the dispatch operation comprises sending the response required to a trigger operation.

28. A method of claim 24 of systematically performing a trigger operation, the trigger operation comprising:
performing a receive response required operation, wherein the receive response required operation comprises accepting a response description from a requirement operation or an external source;
performing a current activity operation, wherein the current activity operation comprises placing the current known activity on an activity comparison table;
performing a response overlay operation, wherein the response overlay operation comprises overlaying the received response activity on the current activity on the activity comparison table;
performing a trigger rules operation, wherein the trigger rules operation comprises defining the need of a new activity trigger where the overlays significantly diverge; and
performing a dispatch operation, wherein the dispatch operation comprises sending the new event trigger to a job.
